(19) United States
(12) Patent Application Publication
(10) Pub. No.: US 2009/0067075 A1
(43) Pub. Date: Mar. 12, 2009

(54) PERSONAL GROOMING MIRROR

(76) Inventor: Robert J. Porter, III, Boise, ID (US)

Correspondence Address: HOLLAND LAW OFFICE P.L.L.C., P.O. BOX 1840, BOISE, ID, 83701-1840, US

(21) Appl. No.: 11/854,310

(22) Filed: Sep. 12, 2007

(51) Int. Cl. G02B 7/182

(52) U.S. Cl. 359/871; 359/838

(57) ABSTRACT

A personal grooming mirror including a mirror housing with a mirror surround aperture formed in a surface of the mirror housing and a mirror contained in the mirror housing with a reflective surface of the mirror exposed and viewable through the mirror surround aperture. The mirror housing is formed in such a manner that a reservoir is defined by a reflective surface of the mirror and a peripheral edge defining the mirror surround aperture. Hot water may be contained within the reservoir prior to use in a humid environment, for instance a shower, to reduce fogging of the reflective surface of the mirror. A grip assist aperture is formed through the mirror housing and is configured to provide a means for securely grasping the personal grooming mirror.

### BACKGROUND OF THE INVENTION

1. Technical Field

The present invention relates generally to personal grooming devices and more particularly to a personal grooming mirror.

2. Background

A variety of mirrors intended for use in connection with personal grooming matters have been disclosed in the prior art. The prior art teaches a variety of personal grooming mirrors that provide light. See for instance U.S. Pat. No. 3,598,987 to Kipping, U.S. Pat. No. 4,880,145 to McManus and U.S. Pat. No. 6,932,488 to Horn.

The prior art also teaches a variety of means for suspending a personal grooming mirror while in use. See U.S. Pat. No. 4,655,559 to Odell and U.S. Pat. No. 4,950,065 to Wyman, (suction cups), U.S. Pat. No. 6,149,277 to Broussard, (clipping to the showerhead) and U.S. Pat. No. 6,443,578 to Finnigan, (hanging from a shower curtain rod). The prior art also describes a variety of personal grooming mirrors that are intended for use in humid conditions, for instance a shower. In most cases, defogging of the mirror is addressed by fluid connection of the mirror assembly to the hot water supply of the shower allowing a flow of heated water through a cavity or compartment of the mirror assembly. See U.S. Pat. No. 4,556,298 to Gottlieb, U.S. Pat. No. 4,557,003 to Jones, U.S. Pat. No. 5,416,635 to Christianson, et al., and U.S. Pat. No. 5,953,157 to Christianson. In at least one instance the mirror includes materials or coatings applied to the surface of a mirror to eliminate fogging. See U.S. Pat. No. 6,443,578 to Finnigan. The prior art also teaches defogging by providing a reservoir that is filled with a hot liquid in order to heat the mirror and make it condensate-free. See U.S. Pat. No. 4,327,961 to Kladitis and U.S. Pat. No. 4,655,559 to Odell.

In an attempt to provide for a personal grooming mirror that may be used in a shower environment, movement or portability of the mirror is impeded by measures taken to reduce fogging, either by fixing the mirror to the plumbing, either physically or hydraulically, or by fixing to a structure surrounding the shower in the case of shower rods and the like. Where the device provides for the possibility of handheld function, little or no consideration is given to device configuration from the standpoint of ergonomics or how the mirror might best interface with the anatomy of the hand to provide for a comfortable and secure grip. Additionally, while the prior art has addressed the problem of reducing fogging of the mirror or condensation of water on the surface of the mirror, there still exists a problem of water both condensed from the immediate atmosphere and from spray from the showerhead accumulating on the mirror thereby reducing or impairing the quality of a reflected image. Similarly, a shortcoming is found in the fact that when light is provided for in a personal grooming mirror, the result is added weight and decreased portability. In like manner, measures taken to provide a softer less direct light, typically by use of optics including diffusers, result in increased weight and diminished portability.

### SUMMARY OF THE INVENTION

The present invention is directed to a personal grooming mirror including a housing, the housing configured to include a grip aperture formed in the housing. In the preferred embodiment, a mirror is fixed with respect to the housing, in such a manner that it is replaceable and interchangeable with mirrors having a variety of levels of magnification or other optical qualities. Alternately a metal-backed mirror may be used in the present invention. A metal-backed mirror provides an additional advantage of top side heating of the mirror in hot water to reduce fogging and condensation. In one embodiment of the invention, the mirror includes a water repellant coating.

The housing is preferably formed so that one or more water flow channels extend from a periphery of the viewable portion of the mirror to a peripheral edge of the housing to facilitate movement of water from the surface of the mirror. The housing and the flow channels are configured so that when the personal grooming mirror is held in a substantially horizontal orientation with the mirror surface facing upward, the housing will retain water, preferably hot water, for the purpose of top side heating of the mirror.

The preferred embodiment of the personal grooming mirror also includes an ergonomic configuration with a grip assist aperture. The grip assist aperture is configured to fit about the base of a user's thumb with the mirror resting in the palm of the hand with opposing fingers griping the mirror about the peripheral edges. Alternately, one or more digits may be placed through the grip assist aperture with the thumb in opposing orientation to the digits placed through the grip assist aperture. In a preferred embodiment, the body of the personal grooming mirror is formed of a molded plastic with a “rubberized” edge surround to increase friction and enhance grip-ability of the personal grooming mirror. The housing is configured to include a cavity for receiving the mirror, which is inserted in the cavity and is held in contact against a mirror display aperture formed in a surface of the housing. Alternately, the housing may be formed of a lightweight metal preferably aluminum, again with a “rubberized” edge surround. An all metal housing would increase thermal capacity and transfer providing improved defogging.

The preferred embodiment of the personal grooming mirror also includes a low voltage solid state light source, for instance a light emitting diode or light emitting polymer, enclosed at least partially within the device housing. In the preferred embodiment, a light emitting diode (LED) element is mounted in the housing at an angle in the range of 30°-60° relative to a plane in which the mirror lies, to provide an “indirect” light. Due to the relatively direct nature of light emitting from an LED, i.e. a conical output beam on the order of 30°, (15° off axis of the conical output beam in any direction), by angling the axis of the conical output beam of the LED, for instance to 45°, light cast within the conical output beam would not impinge directly on the face of a user holding the mirror at an angle that is substantially parallel to a plane of the face.

The present invention is also directed to a personal grooming mirror system that includes a mirror docking station. The mirror docking station is adapted to permit attachment to a surface, for example a shower wall. The docking station is configured having a mirror support that is configured for relatively close tolerance fit within the grip assist aperture of the personal grooming mirror housing. In a preferred embodiment, the mirror support is also configured to hold a shaving razor.

### BRIEF DESCRIPTION OF THE FIGURES

FIG. 1 is a representative perspective view of a personal grooming mirror according to the present invention.

FIG. 2 is a representative front view of a personal grooming mirror system according to the present invention.

FIG. 3 is a representative exploded side view of a personal grooming mirror system according to the present invention.

FIG. 4 is a representative front view of a personal grooming mirror according to the present invention.

FIG. 5 is a representative first side view of a personal grooming mirror according to the present invention.

FIG. 6 is a representative rear view of a personal grooming mirror according to the present invention.

FIG. 7 is a representative second side view of a personal grooming mirror according to the present invention.

FIG. 8 is a representative top view of a personal grooming mirror according to the present invention.

FIG. 9 is a representative bottom view of a personal grooming mirror according to the present invention.

FIG. 10 is a representative cutaway side view of a personal grooming mirror according to the present invention.

FIG. 11 is a representative exploded cutaway side view of a personal grooming mirror according to the present invention.

FIG. 12 is a representative side view of a personal grooming mirror in use according to the present invention.

FIG. 13 is a representative side view of a personal grooming mirror in use according to the present invention.

FIG. 14 is a representative top view of a personal grooming mirror in use according to the present invention.

FIG. 15 is a representative top view of a personal grooming mirror in use according to the present invention.

### DETAILED DESCRIPTION

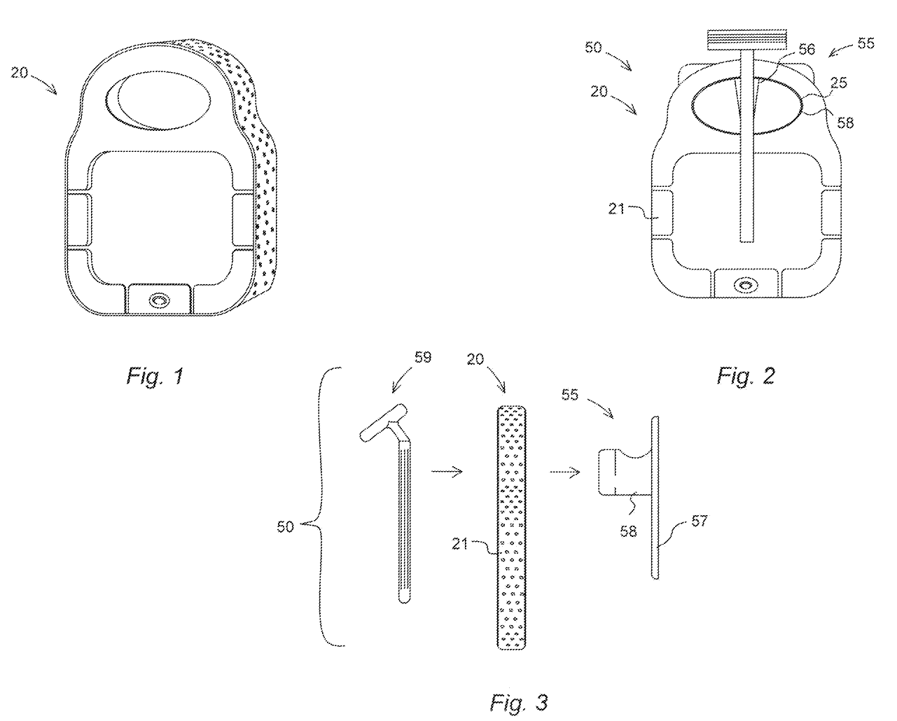

Referring to FIG. 1, a preferred embodiment of personal grooming mirror 20 is shown to advantage.

FIGS. 2 and 3 show personal grooming mirror system 50 including docking station 55 and razor 59. As seen, personal grooming mirror 20 is positioned with post portion 58 of docking station 55 extending through grip aperture 25 formed in housing 21. Razor 59 may be stored in receiver 56 as seen in FIG. 2. Referring to FIG. 3, docking station 55 includes base 57 that may be mounted to a surface, (not shown).

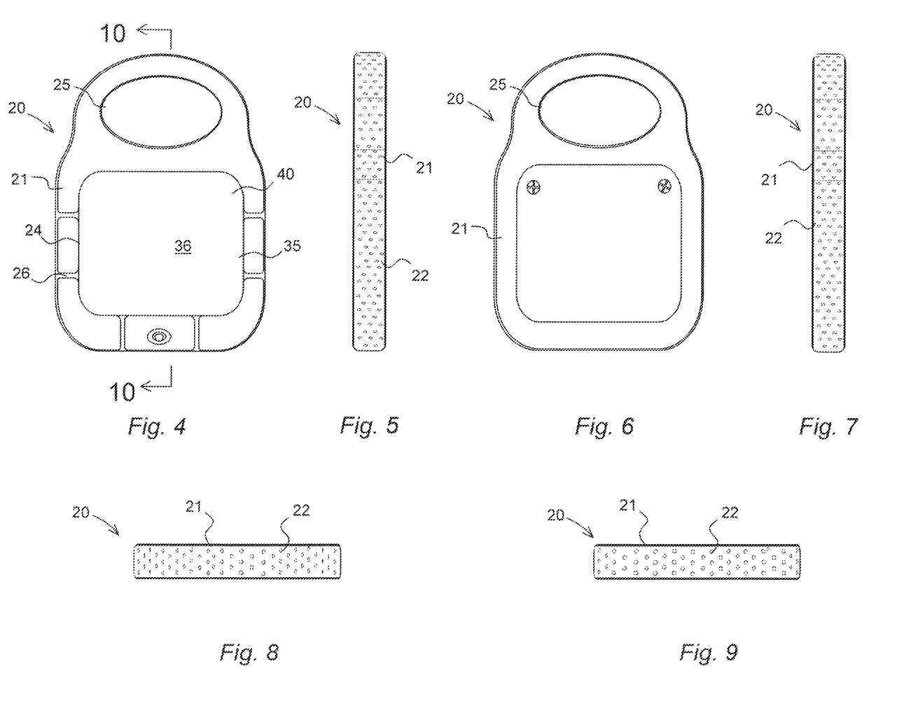

Referring to FIGS. 4 through 9, personal grooming mirror 20 is shown including grip aperture 25 formed in housing 21. Referring to FIG. 4, housing 21 is formed in such a manner as to include mirror surround aperture 24 through which reflective surface 36 of mirror 35 is viewable. Reservoir 40 is defined reflective surface 36 of mirror 35 and a peripheral edge of mirror surround aperture 24. One or more flow channels 26 facilitate the evacuation of water from surface 36 of mirror 35. As seen in FIGS. 5, 7, 8 and 9, personal grooming mirror 20 also includes grip surface 22, which in the preferred embodiment is formed in an over-molding process following initial molding of housing 25.

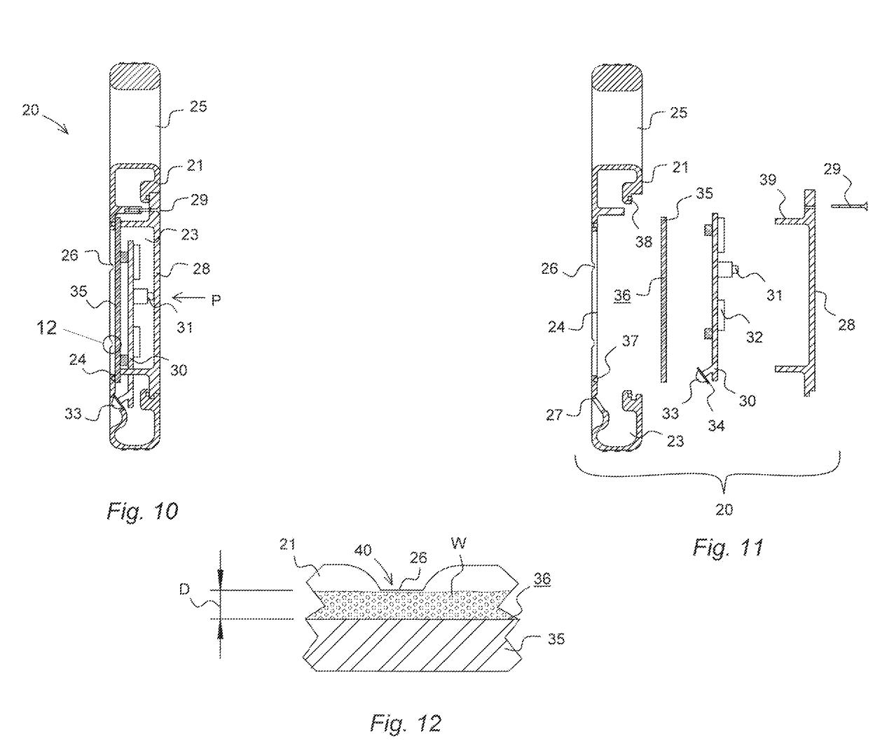

Referring to FIGS. 10 and 11, personal grooming mirror 20 is shown including grip aperture 25 formed in housing 21. Housing 21 is formed having compartment 23 which defines an interior space in which mirror 35 and circuit board 30 are contained. Housing 21 includes mirror surround aperture 24 through which reflective surface 36 of mirror 35 is viewable. Housing 21 includes one or more flow channels 26 which facilitate the evacuation of water from surface 36 of mirror 35. Housing 21 also includes removable back panel 28 that is held in place with screw 29. Seal 37 is interposed between mirror 35 and mirror surround aperture 24. Similarly seal 38 is interposed between back panel 28 and housing 21. Legs 39 of back panel 28 are configured such that when back panel 28 is positioned with respect to housing 21 and held in place with screw 29, a compressive force is exerted against mirror 35, holding mirror 35 in position with respect to mirror surround aperture 24 and seal 37. Housing 21 also includes light source aperture 27, seen in FIG. 11 through which the end of light source 33 projects when personal grooming mirror 20 is assembled as seen in FIG. 10. Seal 34 is interposed between light source 33 and light source aperture 27. As shown in FIGS. 10 and 11, mirror 35 is interchangeable with mirrors having a variety of levels of magnification or other optical qualities.

In the preferred embodiment of the invention, personal grooming mirror 20 includes light source 33 attached to circuit board 30. Switch 31, control circuit 32, power source 34 and light source 33 are all connected to circuit board 30 and are in electrical communication with one another. In the preferred embodiment, light source 33 comprises a light emitting diode. Light source 33 is energized when back panel 28 is depressed as indicated by the arrow P, shown in FIG. 10, deflecting back panel 28 to contact switch 31. In a preferred embodiment, light source 33 remains illuminated for a pre-selected time period and then de-energizes.

Referring to FIG. 12, a detail of flow channel 26 formed in body 21 is shown to advantage. Mirror 35, having reflective surface 36, is positioned in housing 21. Housing 21 is formed such that a depth D is observed between reflective surface 36 and flow channel 26. This feature permits a user to position personal grooming mirror 20 under a source of hot water W in a substantially horizontal orientation, holding a film of hot water W having a depth D in reservoir 40 defined reflective surface 36 of mirror 35 and a peripheral edge of mirror surround aperture 24 against reflective surface 36 to preheat mirror 35 prior to or during use. Once preheating is complete, personal grooming mirror 20 is tipped to a substantially vertical orientation and hot water W is drained from the reflective surface 36. Personal grooming mirror 20 is now ready for use with mirror 35 being pre-heated and therefore less prone to fogging.

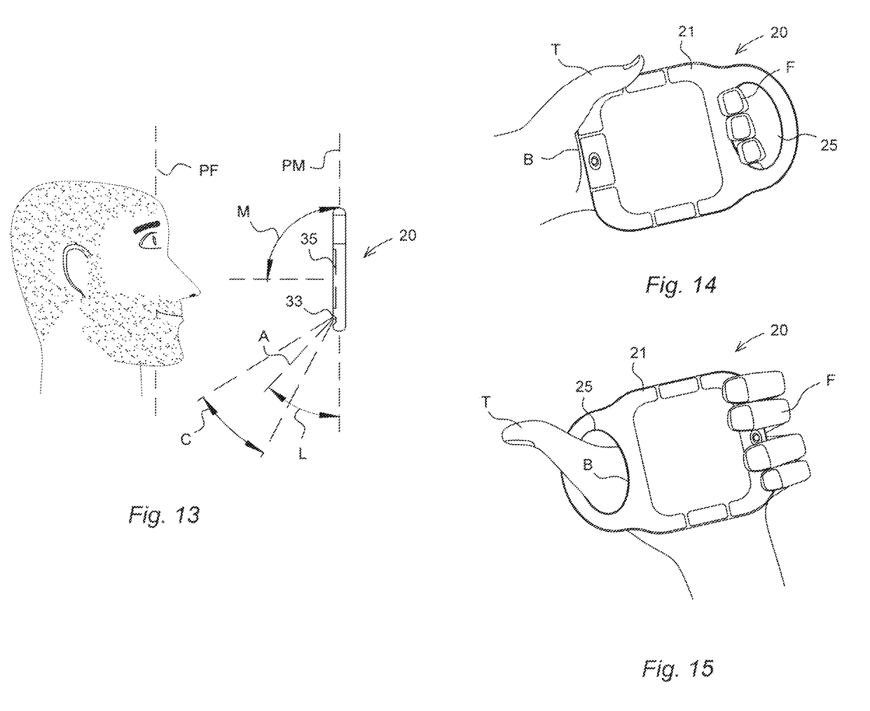

FIG. 13 shows the advantages of the feature of indirect light of the present invention. As shown, personal grooming mirror 20 is held for use in a mirror plane PM that is substantially parallel to a plane of the users face PF, or at an angle M that is substantially perpendicular to a plane of the users face PF. Light source 33 has an axis of illumination A that is oriented at an angle L with respect to mirror plane PM. Light source 33 includes a cone of illumination C that is preferably of the order of 30°, (15° off the axis of illumination A in any direction). Light cast within cone of illumination C would not impinge directly on the plane of the users face PF.

Referring to FIGS. 14 and 15, advantages of the ergonomic design of personal grooming mirror 20 are shown to advantage. As shown in FIG. 14, grip aperture 25 formed in housing 21 is configured having a size and shape that is adapted so that one or more of a users' digits F may be placed through the grip aperture 25 with an opposing edge of housing 21 resting against the base B of the user's thumb T. Alternately as shown in FIG. 15, grip aperture 25 may be placed so that it rests at base B of the user's thumb T. An opposing edge of housing 21 is grasped by users' digits F to hold personal grooming mirror 20 securely during use.

The foregoing description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Process steps described might be interchangeable with other steps in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, or method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . ”

1. A handheld grooming mirror providing top side mirror heating for reducing fogging and condensation, the personal grooming mirror comprising:
a mirror housing including a mirror surround aperture formed in the mirror housing;
a mirror attached to the mirror housing, a reflective surface of the mirror displayed through the mirror surround aperture; and
a reservoir defined by the reflective surface of the mirror and a peripheral edge defining the mirror surround aperture, the reservoir adapted to hold hot water when the mirror housing is positioned in a substantially horizontal orientation, providing top side heating of the mirror to reduce fogging and condensation of the mirror.

2. The handheld grooming mirror of claim 1 wherein the housing further comprises a gripping surface formed on at least a portion of a surface of the housing.

3.

4. The handheld grooming mirror of claim 1 wherein the mirror housing further comprises a grip assist aperture formed through the housing, the grip assist aperture adapted to permit placement one or more fingers of a hand through the grip assist aperture as the mirror housing rests against a palm of the hand.

5. The handheld grooming mirror of claim 1 wherein the mirror housing further comprises a compartment further comprises a compartment partially defined within the housing between the mirror and a removable panel.

6. The handheld grooming mirror of claim 1 wherein the mirror housing further comprises a compartment partially defined within the housing between the mirror and a removable panel, the compartment adapted to house the mirror.

7. The handheld grooming mirror of claim 1 wherein the mirror housing further comprises one or more flow channels extending from the mirror surround aperture towards an outer edge of the mirror housing, each of the one or more flow channels configured to facilitate evacuation of water from the reflective surface of the mirror.

8. The handheld grooming mirror of claim 1 further comprising a light circuit, the light circuit including a power source enclosed within the housing, a light source conductively connected to the power source and a switch conductively connected between the light source conductively connected to the power source.

9. The handheld grooming mirror of claim 1 wherein the mirror further comprises an interchangeable mirror.

10. The handheld grooming mirror of claim 1 wherein the mirror housing further comprises a gripping surface formed on at least a portion of a surface of the mirror housing, the gripping surface formed in an over-molding process.

11. A handheld grooming mirror providing top side heating of the mirror in hot water for reducing fogging and condensation, the personal grooming mirror comprising:
a mirror housing including a mirror surround aperture formed in a surface of the mirror housing;
a mirror contained in the mirror housing with a reflective surface of the mirror exposed and viewable through the mirror surround aperture;
a compartment partially defined within the housing between the mirror and a removable rear panel; and
a reservoir defined by a reflective surface of the mirror and a peripheral edge defining the mirror surround aperture, the reservoir adapted to hold hot water when the mirror housing is positioned in a substantially horizontal orientation, providing top side heating of the mirror to reduce fogging and condensation of the mirror.

12. The handheld grooming mirror of claim 10 wherein the mirror housing further comprises a gripping surface formed on at least a portion of a surface of the housing.

13. The handheld grooming mirror of claim 10 wherein the mirror housing further comprises a grip assist aperture formed through the housing, the grip assist aperture adapted to permit placement one or more fingers of a hand through the grip assist aperture as the mirror housing rests against a palm of the hand.

14. The handheld grooming mirror of claim 10 wherein the mirror further comprises an interchangeable mirror.

15. The handheld grooming mirror of claim 10 wherein the mirror housing further comprises a molded plastic.

16. The handheld grooming mirror of claim 10 wherein the mirror housing further comprises.

17. The handheld grooming mirror of claim 10 wherein the mirror housing further comprises one more water flow channels extending from a periphery of a viewable portion of the mirror to a peripheral edge of the housing to each of the one or more flow channels configured to facilitate evacuation of water from the reflective surface of the mirror.

18. The handheld grooming mirror of claim 10 further comprising a.

19. A handheld grooming mirror providing top side mirror heating for reducing fogging and condensation, the personal grooming mirror comprising:
a mirror housing including a mirror surround aperture formed in a surface of the mirror housing;
the mirror housing including a gripping surface formed in an over-molding process on at least a portion of a surface of the mirror housing;
the mirror housing further including one or more flow channels extending from the mirror surround aperture;
a mirror contained in the mirror housing with a reflective surface of the mirror exposed and viewable through the mirror surround aperture;
a compartment partially defined within the housing between the mirror and a removable rear panel; and
a reservoir defined by a reflective surface of the mirror and a peripheral edge defining the mirror surround aperture, the reservoir adapted to hold hot water when the mirror housing is positioned in a substantially horizontal orientation, providing top side heating of the mirror to reduce fogging and condensation of the mirror.

20. The handheld grooming mirror of claim 18 wherein the mirror further comprises an interchangeable mirror.

20. The handheld grooming mirror of claim 18 wherein the mirror housing further comprises a compartment, the mirror mounted within the compartment.
